(19) United States
(12) Patent Application Publication
(10) Pub. No.: US 2015/0111986 A1
(43) Pub. Date: Apr. 23, 2015

(54) POLYOLEFIN INTUMESCENT PHOSPHOROUS FLAME RETARDANT SYSTEM

(71) Applicant: PolyOne Corporation, Avon Lake, OH (US)

(72) Inventor: Kebin Geng, Solon, OH (US)

(73) Assignee: PolyOne Corporation, Avon Lake, OH (US)

(21) Appl. No.: 14/390,454

(22) PCT Filed: Apr. 4, 2013
(86) PCT No.: PCT/US2013/035320

§ 371 Date: Oct. 3, 2014

Related U.S. Application Data
(60) Provisional application No. 61/621,126, filed on Apr. 6, 2012.

(51) Int. Cl. C09D 5/18; C09K 21/04

(52) U.S. Cl. CPC C09D 5/185; C09K 21/04
USPC 523/179

(57) ABSTRACT

A flame retardant polypropylene compound is disclosed. The compound comprises a polypropylene and non-halogenated ammonium phosphate flame retardant, along with ethylene vinyl acetate, magnesium hydroxide; fluoroelastomer and other functional additives. The compound can achieve a UL 94 rating of V-0 at a thickness of 1.55 mm or greater.

### CLAIM OF PRIORITY

This application claims priority from U.S. Provisional Patent Application Ser. No. 61/621,126 bearing Attorney Docket Number 12012001 and filed on Apr. 6, 2012, which is incorporated by reference.

### FIELD OF THE INVENTION

This invention relates to a polyolefin intumescent phosphorous flame retardant system, which exhibits good flame retardant properties and minimal melt material roll-back acceptable for thin-wall extrusion processing.

### BACKGROUND OF THE INVENTION

Thermoplastic compounds, unlike wood, metal, or glass, do not rot, rust, or shatter. For that reason, the world in the past seventy years has seen a revolution in material science arising from the combination of a thermoplastic resin and one or more functional additives to provide specific properties to the resin.

Unlike wood but like metal and glass, at a given temperature, a thermoplastic resin can melt. Its processing versatility benefits from its capacity to mix with the functional additives while in a molten state.

But in use, the exposure of a fully formed thermoplastic article to excessive heat or flame can be quite detrimental to property and person. Flame retardancy is a key attribute for many household items, for example hair dryers, curtains and drapes, water heaters and kitchen appliances. In addition, materials that are non-flammable and non-combustible are critical for many applications in industries, such as electronics, telecommunications, and transportation. Therefore, flame retardants, drip suppressants, mineral fillers, and char formers are frequently added as functional additives to help thermoplastic compounds retard the effects of heat or flame from melting or even burning.

Recently non-halogenated flame retardants have become popular because they minimize the release of halogenated chemicals if the plastic article would begin to degrade, melt, or burn. However, polymer blends using non-halogenated flame retardants are often more difficult to process and have reduced physical and mechanical properties when compared to the original thermoplastic resin.

### SUMMARY OF THE INVENTION

What the art needs is a non-halogenated thermoplastic compound both capable of passing the Underwriters' Laboratories Test No. 94 (UL 94 test) by achieving a V-0 rating and capable of minimizing roll-back during the thin-wall extrusion processing.

The present invention has found a particular combination of known ingredients which, together, achieve a V-0 rating in a UL 94 test at thicknesses of 1.55 mm or less, and good processability, a task very difficult and unpredictable to achieve.

Starting with a polypropylene copolymer and an ethylene vinyl acetate as the base thermoplastic resins chosen for their physical properties, a non-halogenated flame retardant is combined with other functional ingredients to achieve that coveted V-0 rating.

One aspect of the present invention is a flame retardant polypropylene compound, comprising ethylene vinyl acetate in an amount ranging from about 18 to about 23 weight percent of the compound; polypropylene copolymer in an amount ranging from about 21 to about 26 weight percent of the compound; treated ammonium polyphosphate in an amount ranging from about 35 to about 50 weight percent of the compound; magnesium hydroxide in an amount ranging from about 1 to about 2 weight percent of the compound; fluoroelastomer in an amount ranging from about 0.25 to about 0.35 weight percent of the compound. The ammonium polyphosphate is treated with melamine and coated with an aliphatic thermoplastic polymer having amine end groups.

Optionally, the compound may include one or more of the following: alpha-olefin copolymer, N,N-ethylene bis-stearamide, hindered phenolic antioxidant, phosphite stabilizer, and colorant.

Another embodiment of the invention is a molded article. More specifically a molded article in the form of a conduit for protecting a cable that carry transmissions.

Features of the invention will be explored below.

### BRIEF DESCRIPTION OF THE DRAWINGS

FIG. 1 is an image representing a rating of 5 for “Severe” melt material roll-back in the lab simulation testing described in the Example section.

FIG. 2 is an image representing a rating of 3 for “High” melt material roll-back in the lab simulation testing described in the Example section.

FIG. 3 is an image representing a rating of 1 for “Minimal” melt material roll-back in the lab simulation testing described in the Example section.

### EMBODIMENTS OF THE INVENTION

Ethylene Vinyl Acetate

Ethylene vinyl acetate (EVA) is the copolymer of ethylene and vinyl acetate. U.S. Pat. No. 4,338,227 describes various EVA copolymers and uses thereof. EVA resins are typically soft and flexible, similar to an elastomeric material, yet can be processed like other thermoplastics. In addition EVA maintains flexibility over a broad temperature range of −60° C. to 150° C. and offers excellent crack resistance at low temperatures. A preferred EVA for this invention has a vinyl acetate composition of 28 wt %.

EVA is available in many commercial products, including DuPont's Elvax®, Arkema's Evatane®, and Exxon Mobil's Escorene™.

Polyolefin

Polypropylene is an economical material that offers a combination of outstanding physical, mechanical, thermal, and electrical properties not found in other thermoplastics. For purposes of this invention, polypropylene is intended to cover the homopolymer of propylene as well as various copolymers of propylene and another α-olefin such as ethylene, butylene and the like or mixtures of homopolymer and copolymer. The copolymers can be random copolymers or block copolymers wherein the blocks themselves may be either homopolymers or random copolymers.

There are numerous commercial manufacturers of polypropylene, including LyondellBasell, ExxonMobil, Ineos, Flint Hills Resources, Formosa, Continental Chemical, Sunoco Chemicals, Braskem, Total, Mitsui Chemical and Chisso Chemical Corporation.

Alpha-olefin copolymer

Alpha-olefin copolymers are made by polymerizing an alpha-olefin. This alpha-olefin (or α-olefin) is an alkene where the carbon-carbon double bond starts at the α-carbon atom. Alpha-olefin copolymers are used to improve the impact strength of thermoplastic olefins compounds. Preferred for the invention are ethylene/alpha-olefins, which increase impact absorption and ductility in cold temperatures. Commercial suppliers include Mitsui Chemicals under the brand name Tafmer™ and Dow Chemical under the brand name Infuse™ OBC, which offers several series of alpha-olefin copolymers.

Non-Halogen Ammonium Polyphosphate Flame Retardant

Ammonium polyphosphates can be used as an intumescent flame retardant (FR) system. These systems have the advantage of being formulated without halogens, and, therefore, do not have the environmental regulatory restrictions of halogen-based systems.

Ammonium polyphosphates are an inorganic salt produced from the reaction of polyphosphoric acid and ammonia. Its chemical formula is [NH₄PO₃]ₙ.

When exposed to heat or fire, ammonium polyphosphate will begin to decompose back to ammonia and phosphoric acid. The phosphoric acid acts as a catalyst in the dehydration of carbon-based poly-alcohols, such as cellulose in wood. The phosphoric acid reacts with such alcohol groups to form phosphate esters, which further decompose to release carbon dioxide. The release of non-flammable carbon dioxide, as well as nitrogen further degraded from ammonia and water, reduces the amount of available oxygen to the material that is burning. In contrast, halogen-based systems would result in the release into the environment of gases that contained halogens.

Ammonium polyphosphates FR systems are commercially available from several manufactures, including JLS Chemicals which offers JLS PNP1C, JLS PNP2V, and JLS PNP3D. Other commercial products are Clariant Exolit AP, Amfine FP, Budenheim Budit, Chitec Zuran, and JJI JJAZZ™.

Preferred for the invention is an ammonium polyphosphate FR, for example JLS PNP3D, that is treated with melamine and coated with a low molecular weight (ranging from 500 to 10,000 g/mol) aliphatic thermoplastic polymer coating having amine end groups. This polymer coating treatment greatly improves the compatability between the flame retardant and the polymer matrix. The melamine offers additional nitrogen molecules to be given off as gas during decomposition of the intumescent system. Unlike other ammonium polyphosphates, such as JLS PNP1C and JLS PNP2V, JLS PNP3D is not reacted with vinyl organo-silane, an ingredient used in a surface treatment to reduce the moisture absorption and reduce hygroscopicity of the ammonium phosphate.

Magnesium Hydroxide

Magnesium hydroxide is an inorganic compound with the chemical formula Mg(OH)₂. Unlike when magnesium hydroxide is used as a flame retardant (typically at a higher concentration of 50-70%), the main purpose of magnesium hydroxide in the invention (at a concentration of about 1-2%) is to minimize compound material roll-back by helping to prevent melt build-up in the die. The magnesium hydroxide is preferably synthesized as a powder with a disc- or plate-shaped morphology.

Fluoroelastomer

Fluoroelastomers are highly suitable for harsh environments due to their ability to withstand high temperatures and excellent chemical resistance. Fluoroelastomers may include copolymers of hexafluoropropylene (HFP) and vinylidene fluoride (VDF or VF₂), terpolymers of tetrafluoroethylene (TFE), vinylidene fluoride (VDF) and hexafluoropropylene (HFP) as well as perfluoromethylvinylether (PMVE) containing polymers. Fluoroelsatomers are available in many commercial products, including 3M's Dyneon™, Daikin DAI-EL® and DuPont's Viton® brands.

Ethylene Bis Stearamide

Ethylene bis stearamide (EBS), a saturated fatty acid having 18 carbon atoms, which is derived from stearic acid and ethylenediamine. EBS is a lubricant that stabilizes the dispersion of solid compounding materials, facilitates melt flow, and decreases friction and abrasion of the polymer surface. Commercial products include Dow Chemical Advawax™, Croda Crodamide™ Chemax Performance Maxomer Lube, Lonza Acrawax™, PMC Biogenix Kemamide® and Crompton Kemamide EBS products in powder, flake, prill or bead forms.

Antioxidants

Antioxidants are used to inhibit the oxidation reactions of other molecules in a material. Therefore, they are often used to stabilize the polymer against adverse conditions, such as weather, UV light, and heat. Common antioxidants include polymeric hindered phenols, such as IRGANOX-1010 from Ciba Geigy, and phosphite stabilizers, such as AO-168, which are antioxidants that provide stability in the presence of heat and oxygen.

Optional Additives

The polymer compounds of the present invention can include any conventional plastics additives in any combination that would not deleteriously affect the adhesive properties of the compound. The amount should not be wasteful of the additive or detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; antioxidants; biocides (antibacterials, fungicides, and mildewcides), anti-fogging agents; anti-static agents; bonding, blowing and foaming agents; dispersants; fillers and extenders; smoke suppressants; expandable char formers; impact modifiers; initiators; lubricants; micas; pigments, colorants and dyes; plasticizers; processing aids; other polymers; release agents; silanes, titanates and zirconates; slip and anti-blocking agents; stabilizers; stearates; ultraviolet light absorbers; viscosity regulators; waxes; and combinations of them.

Table 1 shows acceptable ranges of ingredients useful in the present invention, recognizing that the optional ingredients need not be present at all. The compound can comprise the ingredients, consist essentially of the ingredients, or consist of the ingredients. All amounts are expressed in weight percent of the total compound.

TABLE 1

| Ingredient | Acceptable |
|---|---|
| Ethylene vinyl acetate | 18-23 |
| Polypropylene copolymer | 20-26 |
| Fluoroelastomer | 0.25-0.35 |
| Ammonium polyphosphate FR | 32-50 |
| Magnesium hydroxide | 1-2 |
| Alpha-olefin copolymer | 0-15 |
| N,N-ethylene bis-stearamide | 0-2 |
| Optional Other Additives | 0-5 |

Processing

The preparation of compounds of the present invention is uncomplicated. The compound of the present can be made in batch or continuous operations.

Mixing in a continuous process typically occurs in a single or twin screw extruder that is elevated to a temperature that is sufficient to melt the polymer matrix with addition of other ingredients either at the head of the extruder or downstream in the extruder. Extruder speeds can range from about 50 to about 500 revolutions per minute (rpm), and preferably from about 350 to about 450 rpm. Typically, the output from the extruder is pelletized for later extrusion or molding into polymeric articles.

Mixing in a batch process typically occurs in a Banbury mixer that is capable of operating at a temperature that is sufficient to melt the polymer matrix to permit addition of the solid ingredient additives. The mixing speeds range from 60 to 1000 rpm. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one can make articles of any conceivable shape and appearance using compounds of the present invention.

### Usefulness of the Invention

Thermoplastic compounds can be shaped by extrusion, molding, calendering, thermoforming, or other means of shaping into any plastic article usable in an interior or confined space where fire can cause personal injury or property damage. The compounds resist dripping or burning.

Literally any plastic article useful in a human-occupied space such as a building, a vehicle, or a tunnel can benefit from the flame retardancy of this polyolefin compound. In particular, the flame retardant polyolefin compounds are useful for conduits in the wire and cable industry protecting electrical, optical and plenum wires and various other electronic circuitry.

Any plastic article which is currently made from polypropylene compounds can now be made from the non-halogenated flame retardant compound of this invention.

By achieving a UL 94 V-0 rating at a thickness as thin as 0.8 mm ( 1/32 inch), it is known that a plastic article having any larger thickness will also achieve a UL 94 V-0 rating.

In addition, the compounds of this invention will have only minimal melt roll-back, which is important for thin-wall extrusion processing for products such as cable, sheet, film, tubing, fiber and conduit extrusions. Moreover, the roll-back phenomenon becomes more serious when extruding at a higher line speed.

Thermoplastic articles are sold into the following markets: appliance, building and construction, consumer, electrical and electronic, healthcare, industrial, packaging, textiles, transportation, and wire and cable. Compounds of this invention can be used in any of those markets.

Underwriters' Laboratories Test No. UL 94 serves as the litmus test for flame retardant thermoplastic compounds. As seen in Table 2, the V-0 rating is distinguished from V-1 and V-2 ratings, which are not acceptable if one is seeking the best flame retardance rating.

TABLE 2

| Criteria Conditions | V-0 | V-1 | V-2 |
|---|---|---|---|
| Afterflame time for each | ≦10 s | ≦30 s | ≦30 s |
| individual specimen t₁ or t₂ | | | |
| Total afterflame time for any | ≦50 s | ≦250 s | ≦250 s |
| condition set (t₁ plus t₂ for the | | | |
| 5 specimens) | | | |
| Afterflame plus afterglow | ≦30 s | ≦60 s | ≦60 s |
| time for each individual | | | |
| specimen after the second | | | |
| flame application (t₂ + t₃) | | | |
| Afterflame or afterglow of | No | No | No |
| any specimen up to the | | | |
| holding clamp | | | |
| Cotton indicator ignited by | No | No | Yes |
| flaming particles or drops | | | |

An alternative test for flame retardancy is the Limiting Oxygen Index (LOI), measured according to ASTM 2863, which expresses the minimum concentration of oxygen (as a percentage) required for the polymer material to begin to burn.

Examples provide data for evaluation of the unpredictability of this invention.

### EXAMPLES

Table 2 shows the list of ingredients chosen for Examples 1-4 and Comparative Examples A-H. Before reaching these Comparative Examples A-H and Examples 1-5, 79 other examples were attempted but failed. Therefore, Comparative Examples A-H are a small subset of the difficulty in finding a formulation capable of passing the UL 94 test by achieving a V-0 rating and capable of minimizing roll-back during thin-wall extrusion.

TABLE 3

| | | Commercial |
|---|---|---|
| Brand Name | Ingredient and Purpose | Source |
| Tafmer ™ DF840 | Alpha olefin co-polymer | Mitsui Chemicals |
| | (ethylene-butene) for | |
| | flexibility and low cost | |
| Evatane ® 28-05 | EVA (28% vinyl acetate) for | Arkema |
| | flexibility and flame | |
| | retardant compatibility | |
| Flint Hills | Polypropylene co-polymer | Flint Hills |
| Resources ® | for spring-back feature | |
| P9M6K-041 | | |
| Flint Hills | Polypropylene co-polymer | Flint Hills |
| Resources ® PP | for spring-back and higher | |
| AP7535-HS | stiffness | |
| P5M6K-048 | Polypropylene copolymer for | Huntsman |
| CLARIFIED PP | spring-back feature for | |
| | conduit; and higher stiffness | |
| VITON ® | Fluoro-elastomer for | DuPont |
| FREEFLOW Z210 | reducing die drool and | |
| | burning drip suppressant | |
| Advawax 280 | N,N′-ethylene bis-stearamide | Dow |
| | synthetic wax lubricant | |
| OPE A-C ® 629A | Oxidized polyethylene for | Honeywell |
| | external lubrication | |
| Magnifin ® H5HV | Magnesium hydroxide for | Albemarle |
| | reducing die plate-out and | |
| | roll-back | |
| JLS ® PNP3D, | Ammonium polyphosphate | JLS Chemicals |
| PNP1C, PNP2V | based intumenscent flame | |
| | retardant system | |
| AO 1010 | Hindered phenolic | Generic - |
| | antioxidant for processing | Available from |
| | and long-term thermal | several |
| | stability | commercial |
| | | sources including |
| | | Akrochem, BASF, |
| | | and Chemtura. |
| AO 168 | Phosphite stabilizer for | Generic - |
| | processing | Available from |
| | | several |
| | | commercial |
| | | sources including |
| | | Akrochem, BASF, |
| | | and Chemtura. |
| Amfine FP 2200 | Nitrogen-phosphorus- based | Amfine Chemical |
| | intumescent flame retardant | |
| YELLOW CC | Colorant masterbatches | PolyOne |
| PC2/PC3 | | |

Table 4 shows the mixing conditions in a Coperion W&P twin screw extruder.

TABLE 4
Extruder Mixing Conditions
All Comparative Examples and Examples

| | Coperion W&P co-rotating twin screw |
|---|---|
| | extruder, with the following screw sizes: |
| | 25 mm - Examples 3a, 3b, 3c |
| | 26 mm - Examples 1, 2, 4 and |
| Extruder Type | Comparative Examples A-H |
| Zone 1 | 300° F. (149° C.) |
| Zone 2 | 300° F. (149° C.) |
| Zone 3 | 300° F. (149° C.) |
| Zone 4 | 300° F. (149° C.) |
| Zone 5 | 300° F. (149° C.) |
| Zone 6 | 300° F. (149° C.) |
| Zone 7* | 300° F. (149° C.) |
| Zone 8* | 300° F. (149° C.) |
| Die | 350° F. (177° C.) |
| RPM | 150 |
| Pelletizer* | Strand pelletizer |
| Pellet size* | Approximately ⅛″ × ¼″ cylinders |

*Example 3c was cut using and underwater pelletizer instead of a strand pelletizer, which resulted in pellets in the form of ⅛″ circles. Example 3c also had higher temperatures in Zones 7 and 8 of 330° F. and 340° F. respectively.

The extrudate was pelletized for later molding.

Before molding, the pellets were dried for 4-6 hours at 60-75° C. to reduce moisture content. Using a Nissei molding machine, Table 5 shows the settings used to mold test bars of each Example and Comparative Example having a thickness of 118^{th} inch for the following tests: specific gravity measurements according to ASTM D-792, melt flow rate at 190° C. and with a gravimetric weight of 2.16 kg measured according to ASTM D-1238, tensile properties according to ASTM D-638, and Limiting Oxygen Index (LOT) measured according to ASTM D-2863.

TABLE 5
Molding Conditions
All Comparative Examples and Examples
88 ton Nissei molding machine
Drying Conditions before Molding:

| | |
|---|---|
| Temperature (° C.) | 60-75 |
| Time (h) | 4-6 |

Temperatures:

| | |
|---|---|
| Nozzle (° C.) | 166-177 |
| Zone 1 (° C.) | 149-160 |
| Zone 2 (° C.) | 154-166 |
| Zone 3 (° C.) | 166-177 |
| Mold (° C.) | 21-38 |

Speeds:

| | |
|---|---|
| Velocity (mm/sec) | 25.4-50.8 |

Pressures:

| | |
|---|---|
| Pressure (MPA) | 0.1015-0.145 |

Tables 6 and 7 show the recipes for Comparative Examples A-H and Examples 1-5, respectively.

TABLE 6
Formulation in weight percent (%)

| Example | A | B | C | D | E | F | G | H |
|---|---|---|---|---|---|---|---|---|
| TafmerTM DF840 (MI = 3.6) | 15.00 | 13.00 | 13.00 | 18.00 | 15.00 | 15.00 | 18.00 | 12.00 |
| Evatane 28-05 | 23.70 | 22.70 | 22.70 | 22.70 | 23.70 | 23.70 | 22.70 | 23.70 |
| P9M6K-041 | 20.50 | 20.50 | 20.50 | 20.50 | 20.50 | 20.50 | 20.50 | 20.50 |
| PP AP7535-HS | | | | | | | | |
| VITON FREEFLOW Z210 | 0.30 | 0.30 | 0.30 | 0.30 | 0.30 | 0.30 | 0.30 | 0.30 |
| OPE -AC-629A | 2.50 | 2.50 | | 2.50 | 2.50 | 2.50 | 2.50 | 2.50 |
| ADVAWAX 280 | | | 2.50 | | | | | |
| Magnifin H5HV | 1.50 | 1.50 | 1.50 | 1.50 | 1.50 | 1.50 | 1.50 | 1.50 |
| AO 1010 | 0.25 | 0.25 | 0.25 | 0.25 | 0.25 | 0.25 | 0.25 | 0.25 |
| AO 168 | 0.25 | 0.25 | 0.25 | 0.25 | 0.25 | 0.25 | 0.25 | 0.25 |
| JLS PNP1C | | | | 30.00 | 32.00 | | | |
| JLS PNP2V | 32.00 | 35.00 | 35.00 | | | | | |
| JLS PNP3D | | | | | | | | |
| Amfine FP 2200 | | | | | | 30.00 | 32.00 | 35.00 |
| YELLOW CC PC 2 | | | | | | | | |
| COMPLETED XWC1596005P36 | | | | | | | | |
| YELLOW CC PC 3 | 4.00 | 4.00 | 4.00 | 4.00 | 4.00 | 4.00 | 4.00 | 4.00 |
| COMPLETED XWC1596005P65 | | | | | | | | |
| | 100.00 | 100.00 | 100.00 | 100.00 | 100.00 | 100.00 | 100.00 | 100.00 |

TABLE 7
Formulation in weight percent (%)

| Example | 1 | 2 | 3a | 3b | 3c | 4 | 5 |
|---|---|---|---|---|---|---|---|
| TafmerTM DF840 (MI = 3.6) | 15.00 | 13.00 | 12.00 | 12.00 | 12.00 | | |
| Evatane 28-05 | 23.70 | 22.70 | 22.70 | 22.70 | 22.70 | 18.00 | 18.00 |
| P9M6K-041 | 20.50 | 20.50 | 21.50 | 21.50 | 21.50 | | |
| PP AP7535-HS | | | | | | 25.70 | |
| P5M6K-048 | | | | | | | 25.70 |
| VITON FREEFLOW Z210 | 0.30 | 0.30 | 0.30 | 0.30 | 0.30 | 0.30 | 0.30 |
| OPE -AC-629A | 2.50 | 2.50 | 2.50 | 2.50 | 2.50 | 2.00 | 2.00 |
| ADVAWAX 280 | | | | | | 2.00 | 2.00 |
| Magnifin H5HV | 1.50 | 1.50 | 1.50 | 1.50 | 1.50 | 1.50 | 1.50 |
| AO 1010 | 0.25 | 0.25 | 0.25 | 0.25 | 0.25 | 0.25 | 0.25 |
| AO 168 | 0.25 | 0.25 | 0.25 | 0.25 | 0.25 | 0.25 | 0.25 |
| JLS PNP1C | | | | | | | |
| JLS PNP2V | | | | | | | |
| JLS PNP3D | 32.00 | 35.00 | 35.00 | 35.00 | 35.00 | 50.00 | 50.00 |
| Amfine FP 2200 | | | | | | | |
| YELLOW CC PC 2 | | | 4.00 | 4.00 | 4.00 | | |
| COMPLETED XWC1596005P36 | | | | | | | |
| YELLOW CC PC 3 | 4.00 | 4.00 | | | | | |
| COMPLETED XWC1596005P65 | | | | | | | |
| | 100.00 | 100.00 | 100.00 | 100.00 | 100.00 | 100.00 | 100.00 |

Tables 7 and 8 show the following data for Comparative Examples A-H and Examples 1-5, respectively: specific gravity measurements according to ASTM D-792, melt flow rate at 190° C. and with a gravimetric weight of 2.16 kg measured according to ASTM D-1238, tensile properties according to ASTM D-638, flexural modulus measurements according to ASTM D-790, UL 94 VO flame retardant properties; Limiting Oxygen Index (LOI) measured according to ASTM D-2863 and observed melt roll-back during processing.

Roll-back phenomenon is often a serious problem for thin-wall extrusion process. For the examples, melt roll-back was visually observed during processing of the pelletized material. Roll-back represents the build-up of melt material at the exit of the die, which can harmfully affect the extrusion of thin-walled articles. Exposure to continuous heating of the die causes the roll-back material to eventually degrade and break off, sticking to the extruded articles (e.g. the internal or external surfaces of a conduit). In practice the roll-back phenomenon can force a production line to shut down to clean the built-up melt material before resuming processing. Consequently, this reduces productivity and increases the scrape rate, and in the worst cases, such as in continuous cable extrusion, it may be impossible to stop the process to clean the built-up melt material at the die.

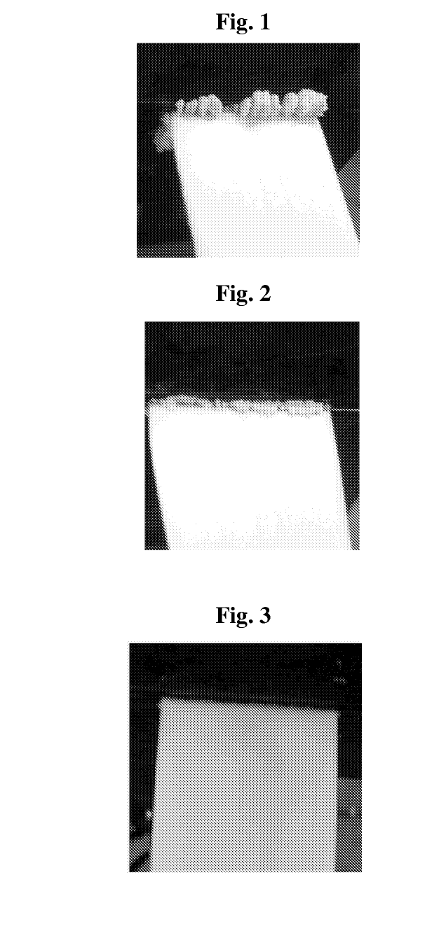

To simulate the roll-back of melt material during processing, the following lab testing method was applied to the examples. A 1-inch single screw Brabender® extruder was employed, having a general metering screw L/D ratio of about 24 and equipped with a narrow mouth die having a dimension of 1 inch in width and 0.02 inches in height. The examples were processed at a temperature of 180° C. in the extruder and across the barrel and through a tape extrusion die at 100 RPM screw speed. The tape extrusion had a draw-down ration about 1/1. The roll-back phenomenon for each example was visually observed after continuously extruding the tape for 10 minutes. The severity of roll-back is qualitatively rated from 0 (none) to 5 (severe). FIGS. 1-3 are representative of the ratings of 5-Severe, 3-High, and 1-Minimal, respectively.

TABLE 8

| Example | A | B | C | D | E | F | G | H |
|---|---|---|---|---|---|---|---|---|
| Specific Gravity | 1.086 | 1.103 | 1.101 | 1.095 | 1.115 | 1.084 | 1.1 | 1.113 |
| Melt Flow Rate (190° C./2.16 | 7.547 | 7.734 | 8.286 | 5.751 | 5.338 | 5.825 | 5.784 | 5.93 |
| kg) | | | | | | | | |
| Moisture Index onsite before | 0.0690 | 0.0685 | 0.0758 | 0.0645 | 0.0669 | 0.0774 | 0.0524 | 0.0615 |
| packed in Al-bags (%) | | | | | | | | |
| Ultimate Tensile @ yield (psi) - | 1419 | 1409 | 1423 | 1520 | 1392 | 1390 | 1350 | 1374 |
| 2 in/min | | | | | | | | |
| Elongation @ Break - 2 in/min | 499 | 493 | 556 | 504 | 456 | 489 | 478 | 483 |
| Flexural Modulus (kpsi) - 0.5 | 33 | 40 | 51 | 33 | 36 | 37 | 36 | 40 |
| in/min | | | | | | | | |
| UL 94 V0; 1.55 mm (about 1/16 | V2 | V1 | V0 | V2 | V0 | V2 | V0 | V0 |
| inch) | 1 non- | 1 non- | no dripping | 3 dripped/ | dripping | 1 dripped | no dripping | no dripping |
| | flame | flame | stretched | 1 ignited | foamed well; | and | smells | smells |
| | dripping/ | dripping | at burning | cotton | slightly | ignited | different | different |
| | 1 ignited | | | | shrink | cotton | | some smoke |
| | cotton | | | | | | | |
| Limiting Oxygen Index | 33.6 | 34.3 | 35.7 | 33.3 | 34 | 36.6 | 40.3 | 40.3 |
| Observation on Roll-back | moderate | moderate | moderate | high roll- | high roll- | severe | severe | severe |
| (0- none; 5- severe) | roll-back (2) | roll-back (2) | roll-back (2.5) | back (3) | back (3.5) | roll-back (5) | roll-back (5) | roll-back (5) |

TABLE 9

| Example | 1 | 2 | 3a | 3b | 3c | 4 | 5 |
|---|---|---|---|---|---|---|---|
| Specific Gravity | 1.0898 | 1.1092 | 1.0970 | 1.1100 | 1.1154 | 1.2080 | 1.207 |
| Melt Flow Rate (190° C./ | 6.66 | 6.635 | 6.91 | 7.62 | 7.814/7.438 | 8.280 | 9.13 |
| 2.16 kg) | | | | | | | |
| Hardness (Shore D): | | | 47.7/42.4 | 47.7/42.1 | 48.4/42.8 | | 61.0/55.0 |
| inst/10 sec delay | | | | | | | |
| Ultimate Tensile @ | 1403 | 1353 | 1296 | 1347 | 1299 | 1320 | 1430 |
| yield (kpsi) - 2 in/min | | | | | | | |
| Elongation @ Break - 2 | 468 | 433 | 476 | 464 | 436 | 16 | 15 |
| in/min | | | | | | | |
| Flexural Modulus | 34 | 36 | 35 | 34 | 46 | 91 | 117 |
| (kpsi) - 0.5 in/min | | | | | | | |
| UL 94 V0, 1.55 mm | V0 | V0 | V0 | V0 | V0 | V0 | V0 |
| | no dripping; | no dripping; | no dripping; | no drip; | no drip; | no dripping | no dripping |
| | foamed well & | foamed well & | foamed well & | foamed well & | foamed well & | or elongated | or elongated |
| | slight shrinkage | slight shrinkage | slight shrinkage | slight shrinkage | slight shrinkage | | |
| UL 94 V0, 0.8 mm | | | | | | V0 | V0 |
| | | | | | | No | Slightly |
| | | | | | | dripping | elongated & |
| | | | | | | | occasionally |
| | | | | | | | dripping but |
| | | | | | | | did not |
| | | | | | | | ignite cotton |

TABLE 9

| Example | 1 | 2 | 3a | 3b | 3c | 4 | 5 |
|---|---|---|---|---|---|---|---|
| Limiting Oxygen Index | 34.4 | 38.2 | 37.2 | 35.9 | 36.0 | 51.7 | 51.7 |
| Observation on Roll- | minimal roll- | minimal roll- | minimal roll- | minimal roll- | minimal roll- | minimal roll- | minimal roll- |
| back (0- none 5- severe) | back (1.5) | back (1.5) | back (1.5) | back (1) | back (1.5) | back (1.5) | back (1.5) |

The use of several different non-halogen flame retardants (FRs) were evaluated to find a polypropylene compound that meets the UL 94 V-0 rating without using a halogenated FR that is also has minimal roll-back for acceptability for thin-wall extrusion processing at high line speeds. Comparative Examples F-H demonstrate that the nitrogen-phosphate based intumescent FR must be at least 32% or greater to achieve a UL 94 V-0 rating; however, Comparative Examples F-H all exhibit severe roll-back, represented by the highest rating of 5 for severe roll-back.

Comparative Examples D and E replace the nitrogen-phosphate based intumescent FR, with JLS PNP1C, an ammonium polyphosphate-based intumescent FR that has been reacted with vinyl organo-silane and is treated with melamine. Comparative Example D fails with a UL 94 V-2 rating as a result of its test samples dripping and one igniting cotton. Comparative Example D also displays high roll-back. Comparative Example E increases the amount of FR that is in Comparative Example D and meets the UL 94 V-0 rating, but has worse roll-back compared to the already unacceptable roll-back of Comparative Example D.

Comparative Examples A-C again replace the FR, using JLS PNP2V, an ammonium polyphosphate-based intumescent FR that has been reacted with vinyl organo-silane, but unlike JLS PNP1C, is not treated with melamine. Comparative Examples A and B fail meeting the UL 94 requirements. Comparative Example B's test samples displayed dripping and Comparative Example A's test samples displayed dripping and ignited the cotton. Comparative Example C met the UL 94 V-0 rating, but showed stretching during the testing, a tendency of the melt dripping. In addition, Comparative Example C displayed moderate roll-back of the melt material during processing.

Examples 1-5 replace the FR, using JLS PNP3D, an ammonium polyphosphate-based intumescent FR that is treated with melamine, and is coated with a low molecular weight thermoplastic containing amine groups. In contrast to JLS PNP1C and JLS PNP2V, JLS PNP3D is not reacted with vinyl organo-silane. Examples 1-5 all achieve the UL 94 V-0 rating, displaying good foaming and no dripping. In addition, Examples 1-5 each exhibit minimal roll-back of melt material acceptable for normal processing requirements. Therefore, unpredictably, the ammonium polyphosphate-based intumescent FR treated with melamine and coated with a low molecular weight thermoplastic containing amine groups was the only non-halogenated FR that could successfully meet both requirements for flame retardancy and processability.

The invention is not limited to the above embodiments. The claims follow.

What is claimed is:

1. A flame retardant polyolefin compound, comprising:
(a) ethylene vinyl acetate in an amount ranging from about 18 to about 23 weight percent of the compound;
(b) polypropylene copolymer in an amount ranging from about 21 to about 26 weight percent of the compound;
(c) ammonium polyphosphate in an amount ranging from about 35 to about 50 weight percent of the compound;
(d) magnesium hydroxide in an amount ranging from about 1 to about 2 weight percent of the compound;
(e) fluoroelastomer in an amount ranging from about 0.25 to about 0.35 weight percent of the compound;
(f) optionally, alpha-olefin copolymer in an amount ranging from 0 to about 12 weight percent of the compound; and
(g) optionally, N,N-ethylene bis-stearamide in an amount ranging from 0 to about 2 weight percent of the compound,
wherein the ammonium polyphosphate is treated with melamine and coated with an aliphatic thermoplastic polymer having amine group end groups.

2. The compound of claim 1, further comprising hindered phenolic antioxidant and phosphite stabilizer.

3. The compound of claim 1, further comprising colorant.

4. The compound of claim 1, further comprising adhesion promoters; antioxidants; biocides (antibacterials, fungicides, and mildewcides), anti-fogging agents; anti-static agents; bonding, blowing and foaming agents; dispersants; fillers and extenders; smoke suppressants; expandable char formers; impact modifiers; initiators; lubricants; micas; pigments, dyes; plasticizers; processing aids; other polymers; release agents; silanes, titanates and zirconates; slip and anti-blocking agents; stabilizers; stearates; ultraviolet light absorbers; viscosity regulators; waxes; and combinations of them.

5. A molded article, comprising a compound of claim 1.

6. The molded article of claim 5, in the form of a conduit for protecting cables that can carry transmissions.
